(19) United States
(12) Patent Application Publication
(10) Pub. No.: US 2016/0156552 A1
(43) Pub. Date: Jun. 2, 2016

(54) FLOW TABLE ENTRY IN SOFTWARE DEFINED NETWORKING

(71) Applicant: HANGZHOU H3C TECHNOLOGIES CO., LTD., Hangzhou, Zhejiang (CN)

(72) Inventor: Jinglin LI, Beijing (CN)

(73) Assignee: Hangzhou H3C Technologies Col, Ltd., Hangzhou City (CN)

(21) Appl. No.: 14/903,248

(22) PCT Filed: Jul. 31, 2014
(86) PCT No.: PCT/CN2014/083369

§ 371 Date: Jan. 6, 2016

(30) Foreign Application Priority Data
Aug. 5, 2013 (CN) 201310337052.3

(51) Int. Cl. H04L 12/721; H04L 29/06

(52) U.S. Cl. CPC H04L 45/566; H04L 69/22

(57) ABSTRACT

According to an example an instruction set of a flow table entry to forward a packet includes an action of inserting a forwarding path link table in the packet. The forwarding path link table includes path information of the forwarding path.

### BACKGROUND

In software defined networking (SDN), there are two device roles: controller and forward devices.

After receiving a packet, a forward device searches a local flow table for a matching table entry according to values of several fields in a header of the packet. If the matching table entry is found, an action indicated in an instruction set of the matching table entry is applied to the packet. Otherwise, the packet is forwarded to the controller. After receiving the packet, the controller calculates a forwarding path for the packet and calculates a forwarding port of each forward device on the forwarding path, generates a flow table entry, and issues the flow table entry to the forward devices on the forwarding path.

The OpenFlow protocol (OFP) is one exemplary SDN protocol which is currently is utilized.

### BRIEF DESCRIPTION OF THE DRAWINGS

Features of the present disclosure are illustrated by way of example and not limited in the following figure(s), in which like numerals indicate like elements, in which:

FIG. 1 shows an SDN network in one or more examples of the present disclosure;

FIG. 2 shows a method for processing a flow table entry in the SDN network in one or more examples of the present disclosure;

FIG. 3 shows a forwarding path link table in one or more examples of the present disclosure;

FIG. 4 shows a simplified forwarding path link table in one or more examples of the present disclosure;

FIG. 5 shows a format of a forwarding link table indicator in FIG. 3 and FIG. 4 in one or more examples of the present disclosure;

FIG. 6 shows a method for processing a flow table entry in the SDN network in one or more examples of the present disclosure;

FIG. 7 shows packet formats of an original packet and a packet inserted with a forwarding path link table in one or more examples of the present disclosure;

FIG. 8 shows a forwarding path link table in one or more examples of the present disclosure;

FIG. 9 shows an example forwarding path link table as shown in FIG. 8 in which device information of a first forward device is popped out according to the present disclosure;

FIG. 10 shows a method for processing a flow table entry in the SDN network in one or more examples of the present disclosure;

FIG. 11 shows a forwarding path link table in one or more examples of the present disclosure;

FIG. 12A and FIG. 12B show structures of a controller in the SDN network in one or more examples of the present disclosure;

FIG. 13A to FIG. 13C show structures of a forward device in the SDN network in one or more examples of the present disclosure;

FIG. 14 shows a hardware structure of a controller in the SDN network in one or more examples of the present disclosure; and

FIG. 15 shows a hardware structure of a forward device in the SDN network in one or more examples of the present disclosure.

### DETAILED DESCRIPTION

Hereinafter, the present disclosure is described in further detail with reference to the accompanying drawings and examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

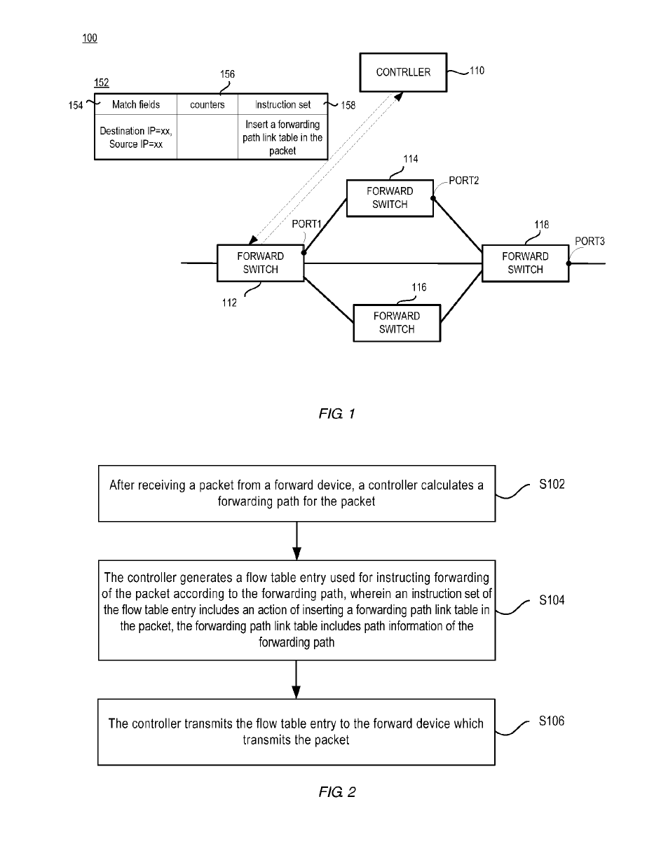

FIG. 1 is a schematic diagram illustrating an SDN network 100 according to an example of the present disclosure. As shown in FIG. 1, the SDN network 100 in the example of the present disclosure includes: a controller 110 and forward devices 112˜118. The controller 110 and the forward devices 112˜118 operate according to an SDN protocol, such as an OpenFlow protocol.

In this example, after receiving a packet transmitted by forward device 112 (referred to as an edge forward device hereinafter for facilitating the description), the controller 110 calculates a forwarding path of the packet and generates a flow table entry 152 used for instructing the forwarding of the packet according to the calculated forwarding path. An instruction set 158 of the generated flow table entry 152 includes an action of inserting a forwarding path link table in the packet, wherein the forwarding path link table includes path information of the forwarding path. Match fields 154 of the flow table entry 154 include several fields of packet header to match against packets. The counter 156 is updated when packets are matched.

Herein, it is assumed that the calculated forwarding path is forward device 112→forward device 114→forward device 118. The controller 110 transmits the flow table entry 152 to the edge forward device 112 and does not need to generate flow table entries and issue them to forward devices 114 and 118 (referred to as intermediate forward devices) on the forwarding path. Thus, the edge forward device 112 is able to process the packet and other packets of the same data flow according to the flow table entry 152, i.e., insert a forwarding path link table including the path information of the forwarding path in the packet and forward the packet. As such, following intermediate forward devices 114 and 118 on the forwarding path may forward the packet according to the path information of the forwarding path inserted in the packet. Therefore, the intermediate forward devices 114 and 118 need not process the packet according to flow table entries. The controller 110 does not need to generate flow table entries and issue them to the intermediate forward devices 114, 116 and 118. In view of the above, it may be sufficient for the controller 110 to simply issue a flow table entry to the edge forward device 112, which reduces burden of the controller 110 on issuing flow table entries and increases service deployment efficiency.

For simplifying the description, in the following examples, with respect to one kind of data flow, roles of the forward devices via which the data flow is transmitted are divided as follows.
Edge forward device: it is the first forward device which receives the data flow, i.e., the first forward device via which the data flow enters the SDN network.
Intermediate forward devices: they are forward devices except for the edge forward device that the data flow passes through.

FIG. 2 is a flowchart illustrating a method for processing a flow table entry at a controller end according to one or more examples of the present disclosure. As shown in FIG. 2, the method includes the following.

At block S102, after receiving a packet transmitted by an edge forward device, a controller calculates a forwarding path of the packet.

The controller collects link status and topology information of forward devices and calculates a route (forwarding path) for a data flow to be forwarded. The controller may also manage and monitor each forward device.

At block S104, the controller generates a flow table entry for instructing forwarding of the packet according to the calculated forwarding path, wherein an instruction set of the generated flow table entry includes an action of inserting a forwarding path link table in the packet, wherein the forwarding path link table includes path information of the forwarding path.

The path information of the forwarding path includes device information of each forward device on the forwarding path. The sequence of the device information of the forward devices complies with the sequence of the forward devices on the forwarding path. The device information may be denoted by “forward device”+“forwarding port”, i.e., the device information of a forward device may include a forward device identifier and a port identifier of a forwarding port from which the packet is forwarded. Or, the device information may also be denoted by the forwarding port for simplicity. That is, the device information of the forward device includes the port identifier of the forwarding port from which the packet is forwarded.

If the device information is denoted by “forward device”+“forwarding port”, the forwarding path link table may be as shown in FIG. 3. In FIG. 3, the first forward device that the data flow passes by is the edge forward device of the data flow. The second to the last forward devices are intermediate forward devices of the data flow. As shown in FIG. 3, the device information includes forward device identifiers 310-1, 310-2, . . . , 310-n and port identifiers 320-1, 320-2, . . . , 320-n, wherein n denotes the number of forward devices on the forwarding path. In one or more examples, besides the path information of the forwarding path, the forwarding path link table may further include a link table length field 301. An initial value of the link table length field 301 equals to the total number of forward devices on the forwarding path.

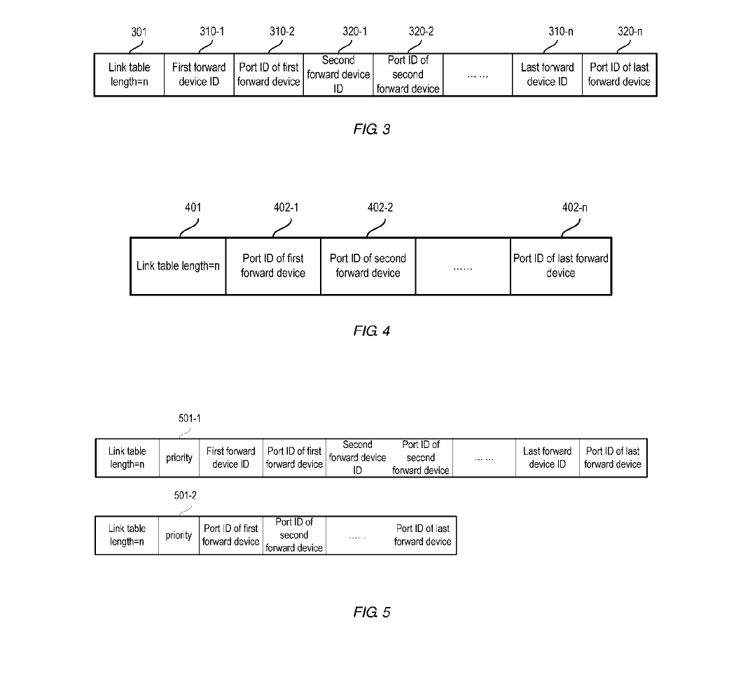

If the device information is denoted by the forwarding port, the forwarding path link table may be as shown in FIG. 4. The device information includes port identifiers 410-1, 410-2, . . . , 410-n of n forward devices. Similarly, the forwarding path link table as shown in FIG. 4 may further include a link table length field 401. An initial value of the link table length field 401 equals to the total number of forward devices on the forwarding path.

In one or more examples, besides the link table length and the device information, the forwarding path link table may further include a priority field (501-1, 501-2), as shown in FIG. 5. Thus, the forward devices may schedule the packet according to the priority.

At block S106, the controller transmits the generated flow table entry to the edge forward device.

The controller issues the flow table entry to the edge forward device and does not issue the flow table entry to the intermediate forward devices. In other words, the intermediate forward devices do not have the flow table entry used for instructing the forwarding of the packet.

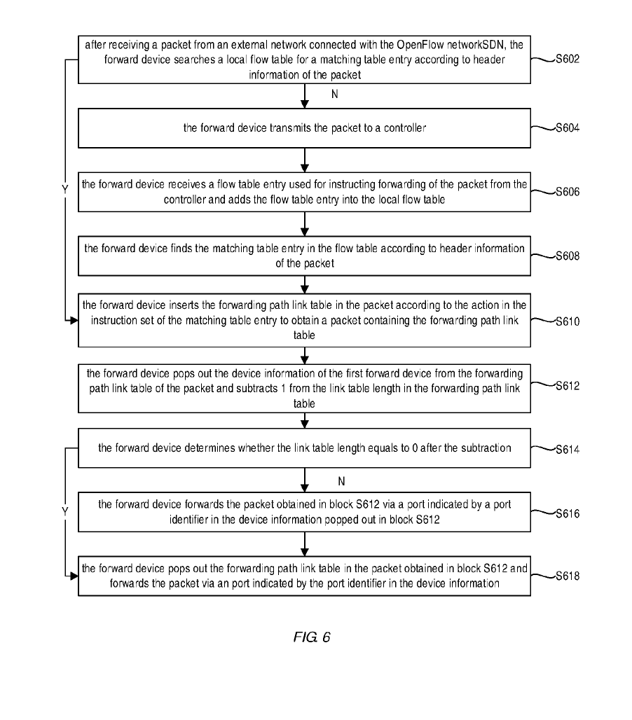

FIG. 6 is a flowchart illustrating a method for processing a flow table entry in the SDN at a forward device end according to one or more examples of the present disclosure. As shown in FIG. 6, the method includes the following.

At block S602, after receiving a packet from a client device or an external network connected with the SDN, the forward device searches a local flow table for a matching table entry according to header information of the packet. If the forward device does not find a matching table entry, block S604 is performed; otherwise, block S610 is performed.

In one or more examples, if the received packet does not contain a forwarding path link table, it indicates that the packet is from an external network and the current forward device is an edge forward device for the packet.

At block S604, the forward device transmits the packet to a controller. Then the method proceeds with block S606.

In blocks S602˜S604, the forward receives a packet of a new data flow and transmits a first packet of the data flow to the controller for path calculation. In block S604, after the forward device transmits the packet to the controller, the controller may operate according to blocks S102˜S106. The operations are not repeated herein.

At block S606, the forward device receives a flow table entry used for instructing forwarding of the packet from the controller and adds the flow table entry into the local flow table, wherein an instruction set of the flow table entry includes an action of inserting a forwarding path link table in the packet, the forwarding path link table includes path information of the forwarding path. Then the method proceeds with block S608.

The forwarding path link table may be as shown in FIG. 3 to FIG. 5 and is not described herein.

At block S608, the forward device finds the matching table entry in the flow table according to header information of the packet. Then the method proceeds with block S610.

At block S610, the forward device inserts the forwarding path link table in the packet according to the action in the instruction set of the matching table entry to obtain a packet containing the forwarding path link table. Then the method proceeds with block S612.

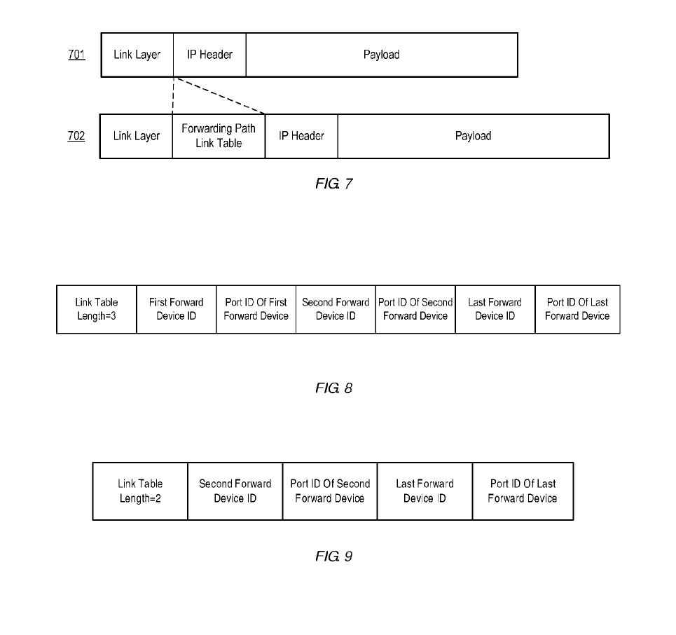

In one or more examples, the packet (referred to as an original packet) received by the forward device from the external network may be the original packet 701 as shown in FIG. 7. When the forwarding path link table as shown in FIG. 3 or FIG. 4 is inserted in the packet, the forwarding path link table may be inserted between a link layer and an IP header of the original packet. The packet containing the forwarding path link table may be the packet 702 as shown in FIG. 7.

At block S612, the forward device pops out the device information of the first forward device from the forwarding path link table of the packet and subtracts 1 from the link table length in the forwarding path link table. Then the method proceeds with block S614.

In the forwarding path link table, since the device information of the forward devices are arranged according to the sequence of the forward devices on the forwarding path, the device information of the first forward device in the forwarding path link table is the device information of the current forward device.

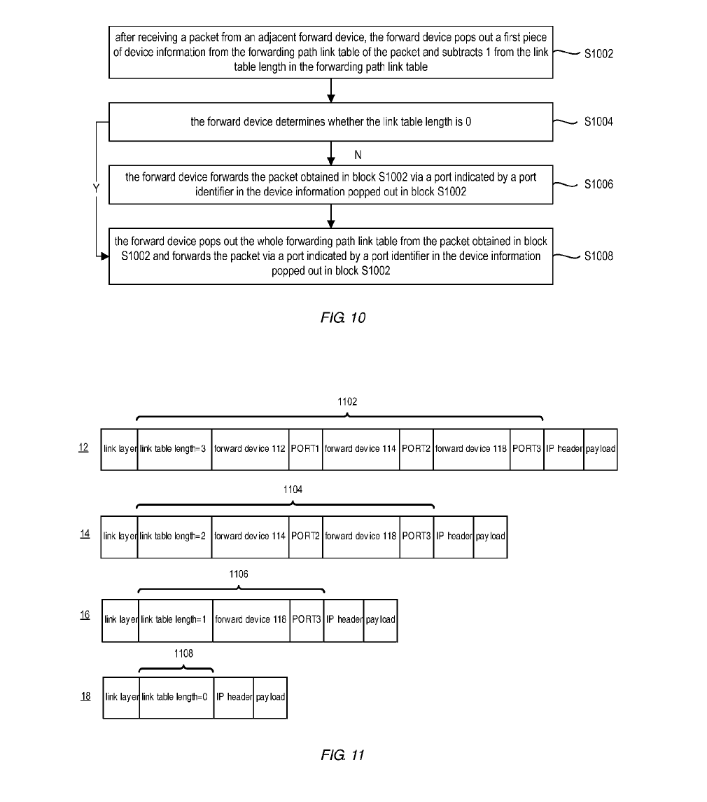

It is assumed that the forwarding path link table in the packet obtained in block S610 is as shown in FIG. 8. Then, the forwarding path link table in the packet after block S612 may be as shown in FIG. 9.

At block S614, the forward device determines whether the link table length equals to 0 after the subtraction. If not, block S616 is performed. Otherwise, block S618 is performed.

At block S616, the forward device forwards the packet obtained in block S612 via a port indicated by a port identifier in the device information popped out in block S612.

At block S618, the forward device pops out the forwarding path link table in the packet obtained in block S612 and forwards the packet via an port indicated by the port identifier in the device information.

In block S618, if the link table length after the subtraction is 0, it indicates that the current forward device is the last forward device that the packet passes by. The whole forwarding path link table in the packet is popped out to obtain the original packet. The original packet is forwarded. Since the device information has been popped out, in this block, what is required to be popped out is the link table length, or the link table length and the priority.

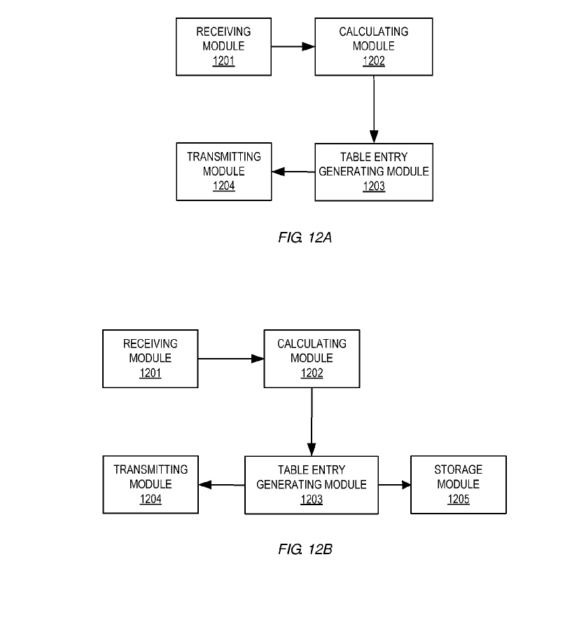

In addition, if a forward device acts as an intermediate forward device of a data flow, the forward device may receive a packet from an adjacent forward device (the adjacent forward device may be an edge forward device or an intermediate forward device of the data flow). At this time, the forward device may perform the following operations, as shown in FIG. 10.

At block S1002, after receiving a packet from an adjacent forward device, the forward device pops out a first piece of device information from the forwarding path link table of the packet and subtracts 1 from the link table length in the forwarding path link table.

At block S1004, the forward device determines whether the link table length is 0. If no, block S1006 is performed. Otherwise, block S1008 is performed.

At block S1006, the forward device forwards the packet obtained in block S1002 via a port indicated by a port identifier in the device information popped out in block S1002.

At block S1008, the forward device pops out the whole forwarding path link table from the packet obtained in block S1002 and forwards the packet via a port indicated by a port identifier in the device information popped out in block S1002.

In view of the above, the edge forward device of the data flow needs to receive and save the flow table entry including the path information of the forwarding path of the data flow issued by the controller. The intermediate forward devices do not need to receive and save flow table entries. Therefore, operations such as table entry insertion, aging and refresh are avoided. Table entry matching operations are also avoided in the intermediate forward devices. Thus, software and hardware design and development of the intermediate forward device are simplified. There is no table entry scale restriction and ternary content addressable memory (TCAM) cost problem. Service capacity of the whole SDN network is increased.

In addition, the intermediate forward device is not required to search flow table and forward the packet according to information such as IP address in the packet header. Therefore, IP addresses may be deployed repeatedly, which facilitates implementation of a virtual private network (VPN) model.

In the examples of the present disclosure, a new field, i.e., the forwarding path link table, is added in the original packet. Thus, the length of the packet is increased and may exceed a maximum length allowed by the link layer. Therefore, the edge forward device may divide the original packet into segments and insert the forwarding path link table into each segment.

The SDN as shown in FIG. 1 is taken as an example to describe the above method. The SDN as shown in FIG. 1 includes a controller and forward devices 112˜118.

After receiving a packet from a client device or an external network, forward device 112 searches a flow table according to information in a packet header for a matching table entry. If there is no matching table entry, forward device 112 transmits the packet to the controller 110. The controller 110 determines the forwarding path of the packet. Suppose that the forwarding path is forward device 112→forward device 114→forward device 118. The controller 110 generates a flow table entry used for instructing the forwarding of the packet according to the forwarding path and transmits the flow table entry to forward device 112. The flow table entry may be as shown in table 1.

TABLE 1

| Match fields | Counter | Instruction set |
|---|---|---|
| Destination IP = xx, | | Insert a forwarding path link |
| source IP = xx | | table 1102 as shown in FIG. |
| | | 11 in the packet |

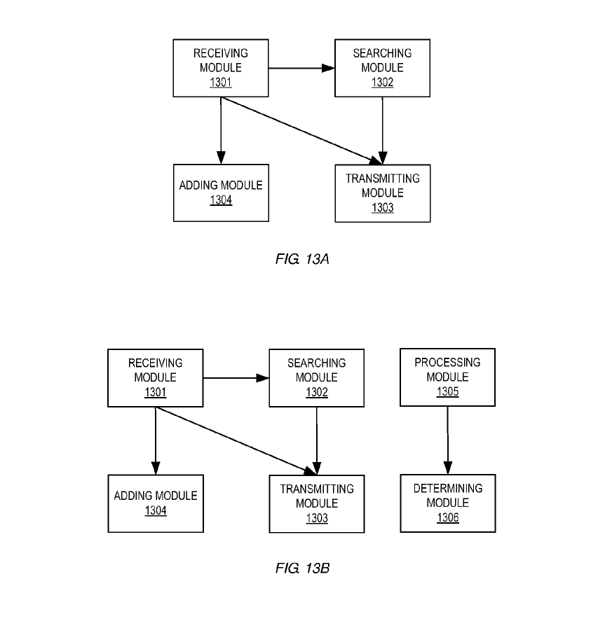

After receiving the flow table entry as shown in table 1, the forward device 112 adds the flow table entry into its flow table and searches the flow table for a matching flow table entry again according to the information in the packet header. At this time, the flow table entry as shown in table 1 is found. According to the instruction set of the flow table entry, the forwarding path link table 1102 in FIG. 11 is inserted in the packet to obtain a packet 12. The first piece of device information, i.e., forward device 112 and PORT1 is popped out from the forwarding path link table 1102 of the packet 12 to obtain packet 14. The link table length is decreased by 1. It is determined whether the link table length is 0. If it is not 0, the packet 14 is forwarded via PORT1 in the device information popped out, so as to arrive at the forward device 114.

After receiving the packet 14, forward device 114 pops out the first piece of device information, i.e., forward device 114 and PORT2 in the forwarding path link table 1104 of the packet 14 to obtain a packet 16. The link table length is decreased by 1. It is determined whether the link table length is 0. If it is not 0, the packet 16 is forwarded via PORT2 in the device information popped out, so as to arrive at the forward device 118.

After receiving the packet 16, forward device 118 pops out the first piece of device information, i.e., forward device 118 and PORT3 in the forwarding path link table 1106 of the packet 16 to obtain a packet 18. The link table length is decreased by 1. It is determined whether the link table length is 0. At this time, the result is 0. The whole forwarding path link table 1108 is popped out from the packet 18 to obtain the original packet. The original packet is then forwarded via PORT3 in the device information popped out, so as to arrive at a destination device.

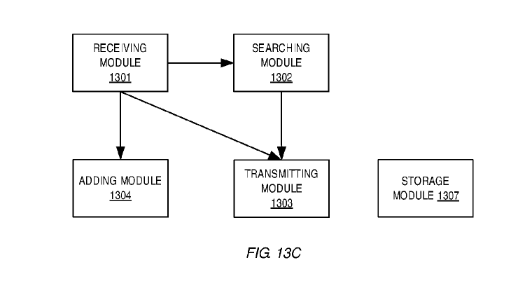

In accordance with the above method, an example of the present disclosure provides a controller, as shown in FIG. 12A. The controller includes a receiving module 1201, a calculating module 1202, a table entry generating model 1203 and a transmitting module 1204.

The receiving module 1201 receives a packet transmitted by a forward device.

The calculating module 1202 calculates a forwarding path of the packet after the receiving module 1201 receives the packet transmitted by the forward device.

The table entry generating module 1203 generates a flow table entry used for instructing forwarding of the packet according to the forwarding path calculated by the calculating module 1202, wherein the generated flow table entry includes an action of inserting a forwarding path link table in the packet, the forwarding path link table includes path information of the forwarding path.

The transmitting module 1204 transmits the flow table entry generated by the flow table entry generating module 1203 to the forward device from which the packet was received.

The forwarding path link table may further include a link table length. An initial value of the link table length equals to the total number of forward devices on the forwarding path. The path information of the forwarding path includes device information of each forward device on the forwarding path. The sequence of the device information of the forward devices complies with the sequence of the forward devices on the forwarding path. The device information of the forward device includes an identifier of the forward device and a port identifier of a forwarding port for forwarding the packet, or includes a port identifier of a forwarding port for forwarding the packet.

In a practical application, the controller may further include a storage module 1205, as shown in FIG. 12B. The storage module 1205 stores the flow table entry generated by the flow table entry generating module 1203, the forwarding path link table included in the flow table entry and the packet transmitted by the forward device.

In accordance with the above method, an example of the present disclosure provides a forward device in an SDN network, as shown in FIG. 13A. The forward device includes a receiving module 1301, a searching module 1302, a transmitting module 1303 and an adding module 1304.

The receiving module 1301 receives a packet from a client device or an external network connected with the SDN network, and receives a flow table entry used for instructing forwarding of the packet transmitted by a controller.

The searching module 1302 searches a flow table of the forward device according to information in a packet header for a matching table entry after the receiving module 1301 receives the packet from the external network.

The transmitting module 1303 transmits the packet to the controller if the searching module 1302 does not find a matching table entry.

The adding module 1304 adds the flow table entry received by the receiving module 1301 in the flow table of the forward device, wherein an instruction set of the flow table entry includes an action of inserting a forwarding path link table in the packet, the forwarding path link table includes path information of the forwarding path.

The forwarding path link table may further include a link table length. An initial value of the link table length equals to the total number of forward devices on the forwarding path. The path information of the forwarding path includes device information of each forward device on the forwarding path. The sequence of the device information of the forward devices complies with the sequence of the forward devices on the forwarding path. The device information of the forward device includes an identifier of the forward device and a port identifier of a forwarding port for forwarding the packet, or includes a port identifier of a forwarding port for forwarding the packet.

The forward device may further include a processing module 1305 and a determining module 1306, as shown in FIG. 13B.

The searching module 1302 searches the flow table according to the information of the packet header for the matching table entry after the adding module 1304 adds the flow table entry received by the receiving module 1301 into the flow table.

The processing module 1305 inserts the forwarding path link table in the packet according to the action in the instruction set of the matching table entry found by the searching module 1302 to obtain a packet containing the forwarding path link table, and pops out a first piece of device information from the forwarding path link table and subtracts 1 from the link table length.

The determining module 1306 determines whether the link table length after the subtraction of the processing module 1305 is 0.

The transmitting module 1303 transmits, if the determining module 1303 determines that the link table length is not 0, the packet via a port identified by a port identifier in the device information popped out by the processing module 1305.

In addition, the receiving module 1301 may further receive a packet containing a forwarding path link table from an adjacent forward device. The processing module 1305 pops out the first piece of device information from the forwarding path link table of the packet after the receiving module 1301 receives the packet from the adjacent forward device, and subtracts 1 from the link table length of the forwarding path link table.

The processing module 1305 pops out the forwarding path link table if the determining module 1306 determines the link table length is 0. And the transmitting module 1303 transmits the packet via a port identified by a port identifier in the device information popped out by the processing module 1305.

In a practical application, the forward device may further include a storage module 1307, as shown in FIG. 13C. The storage module 1307 stores the flow table of the forward device, the packet from the external network, and the packet containing the forwarding path link table. The flow table of the forward device includes a plurality of flow table entries transmitted by the controller.

The above examples may be implemented by hardware, software, firmware, or a combination thereof. For example the various methods, processes and functional modules described herein may be implemented by a processor. Further, the examples disclosed herein may be implemented in the form of a software product. The computer software product is stored in a non-transitory storage medium and comprises a plurality of instructions for making a computer device (which may be a personal computer, a server or a network device, such as a router, switch, access point, etc.) implement the method recited in the examples of the present disclosure.

The above describes the controller and the forward device provided by the examples of the present disclosure. Hereinafter, exemplary hardware structures of the controller and the forward device in the examples of the present disclosure are provided.

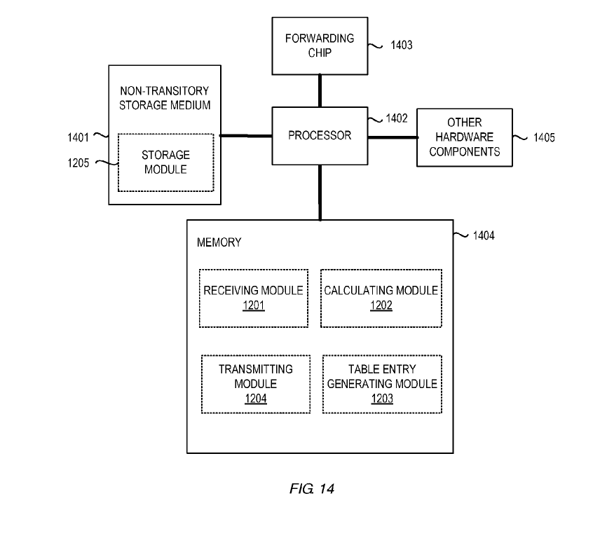

The controller may be a programmable device implemented by hardware and software in combination, as shown in FIG. 14. FIG. 14 is a schematic diagram illustrating a hardware structure of a controller in one or more examples of the present disclosure. The controller includes a non-transitory storage medium 1401, a processor 1402, a forwarding chip 1403, and a memory 1404.

The memory 1404 stores machine readable instructions. When the machine readable instructions are executed, functions of the receiving module 1201, the calculating module 1202, the table entry generating module 1203 and the transmitting module 1204 in the controller are implemented. The functions are not repeated herein.

The processor 1402 communicates with the forwarding chip 1403 to receive and transmit various packets, including receiving a packet from a forward device and transmit the generated flow table entry to the forward device. The processor 1402 communicates with the memory 1404 to read and execute the machine readable instructions stored in the memory 1404, so as to implement the functions of the receiving module 1201, the calculating module 1202, the table entry generating module 1203 and the transmitting module 1204 in the controller. The processor 1402 communicates with the non-transitory storage medium 1401 to read/write data (e.g., the flow table entry) from/to the non-transitory storage medium 1401.

The receiving module 1201 receives from the forwarding chip 1403 the packet transmitted by the forward device, and writes the packet into the storage module 1205 for storage. The calculating module 1202 calculates a forwarding path of the packet and outputs the forwarding path to the table entry generating module 1203 after the receiving module 1201 receives the packet transmitted by the forward device. The table entry generating module 1203 generates a flow table entry for instructing forwarding of the packet according to the forwarding path outputted by the calculating module 1202, and writes the flow table entry into the storage module 1205 for storage. The instruction set of the generated flow table entry includes an action of inserting a forwarding path link table in the packet, wherein the forwarding path link table includes path information of the forwarding path. The transmitting module 1204 transmits the flow table entry generated by the table entry generating module 1203 to the forwarding chip 1403.

The forwarding chip 1403 is connected with the forward device via a port on the forwarding chip and is responsible for reception and transmission of various packets. For example, the forwarding chip 1403 transmits the flow table entry transmitted by the processor 1402 to the forward device, and submits the packet received from the forward device to the processor 1402.

The non-transitory storage medium 1401 stores various kinds of data, including the packet from the forward device, the flow table entry generated by the processor 1402 and the forwarding path link table included in the flow table entry. It implements functions of the storage module 1205 in the controller. The storage module 1205 stores the packet of the forward device submitted by the forwarding chip 1403, the flow table entry generated by the processor 1402 and the forwarding path link table included in the flow table entry.

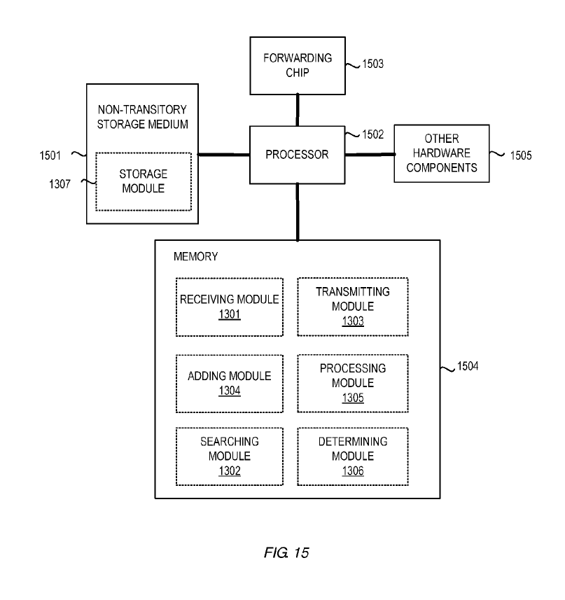

Similarly, the forward device may also be a programmable device implemented by software and hardware in combination, as shown in FIG. 15. FIG. 15 is a schematic diagram illustrating a hardware structure of a forward device in one or more examples of the present disclosure. The forward device includes: a non-transitory storage medium 1501, a processor 1502, a forwarding chip 1503, and a memory 1504.

The memory 1504 stores machine readable instructions. When the machine readable instructions are executed, functions of the receiving module 1301, the searching module 1302, the transmitting module 1303, the adding module 1304, the processing module 1305 and the determining module 1306 are implemented. The functions are not repeated herein.

The processor 1502 communicates with the forwarding chip 1503 to realize transmission and reception of various packets, including receiving the packet from the external network connected with the SDN network, receiving the flow table entry from the controller, transmitting the packet to the controller. The processor 1502 also communicates with the memory 1504 to read and execute the machine readable instructions in the memory, so as to implement the functions of the receiving module 1301, the searching module 1302, the transmitting module 1303, the adding module 1304, the processing module 1305 and the determining module 1306. The processor 1502 also communicates with the non-transitory storage medium 1501 to read/write data (i.e., the flow table entry) from/to the non-transitory storage medium 1501.

The receiving module 1301 receives the packet from the external network via the forwarding chip 1503, writes the packet in the storage module 1307 for storage, and receives the flow table entry used for instructing the forwarding of the packet from the controller via the forwarding chip 1503. The receiving module may also receive a packet containing a forwarding path link table from an adjacent forward device.

The searching module 1302 searches the flow table in the storage module 1307 according to information in a packet header for a matching table entry after the receiving module 1301 receives the packet from the external network. the searching module 1302 may find the matching table entry in the flow table according to the information of the packet header after the adding module 1304 adds the flow table entry in the flow table in the storage module 1307.

The transmitting module 1303 transmits, if the searching module 1302 does not find the matching table entry, the packet to the forwarding chip 1503 which further transmits the packet to the controller. If the determining module 1306 determines that the link table length is not 0, the transmitting module 1303 transmits the packet containing the forwarding path link table to the forwarding chip 1503 which further transmits the packet via a port identified by a port identifier in device information popped out by the processing module 1305. The transmitting module 1303 transmits the packet in which the forwarding path link table has been popped out by the processing module 1305 to the forwarding chip 1503. The forwarding chip 1503 transmits the packet via a port identified by a port identifier in the device information popped out by the processing module 1305.

The adding module 1304 adds the flow table entry received by the receiving module 1301 to the flow table in the storage module 1307, wherein an instruction set of the flow table entry includes an action of inserting a forwarding path link table in the packet, the forwarding path link table includes path information of the forwarding path.

The processing module 1305 inserts the forwarding path link table in the packet according to the action in the instruction set of the matching table entry found by the searching module 1302 to obtain a packet containing the forwarding path link table. The processing module 1305 further pops out the first piece of device information in the forwarding path link table of the packet and subtract 1 from the link table length of the forwarding path link table. If the determining module 1306 determines that the link table length is 0, the processing module 1305 pops out the forwarding path link table from the packet and transmits the packet to the transmitting module 1303. After the receiving module 1301 receives a packet containing a forwarding path link table from an adjacent forward device, the processing module 1305 pops out the first piece of device information from the forwarding path link table of the packet and subtract 1 from the link table length of the forwarding path link table.

The determining module 1306 determines whether the link table length after the subtraction is 0.

The forwarding chip 1503 is connected with the controller and the external network via ports on the forwarding chip and is responsible for transmission and reception of various packets.

The non-transitory storage medium 1501 stores various kinds of data, including the flow table entry in the flow table and the forwarding path link table included in the flow table entry, the packet containing the forwarding path link table, and the packet from the external network. The non-transitory storage medium 1501 implements the functions of the storage module 1307.

It should be noted that, FIG. 14 and FIG. 15 merely show an example of a controller and an example of a forward device. The forward device and the controller may also be implemented via other structures. For example, the various modules, forwarding chip and/or functions described above may be implemented by executing the above described machine readable instructions on a processor or may be realized by a dedicated hardware device such as an application specific integrated circuit (ASIC) or field programmable gate array (FPGA) or by a combination of hardware and machine readable instructions executed on a processor. In addition, there may be one or more processors. If there is a plurality of processors, the processors coordinate to read and execute the machine readable instructions. Therefore, the detailed structures of the controller and the forward device are not restricted in the present disclosure.

In examples of the present disclosure, after receiving a packet from the edge forward device, the controller calculates a forwarding path for the packet and generates a flow table entry used for instructing forwarding of the packet according to the forwarding path, wherein the instruction set of the generated flow table entry includes an action of inserting a forwarding path link table in the packet, the forwarding path link table includes path information of the forwarding path. The controller transmits the flow table entry to the edge forward device and does not need to generate flow table entries and issue them to intermediate forward devices on the forwarding path. Thus, the edge forward device is able to process the packet and other packets of the same data flow according to the flow table entry, i.e., insert a forwarding path link table including the path information of the forwarding path in the packet and forward the packet. As such, following intermediate forward devices on the forwarding path may forward the packet according to the path information of the forwarding path inserted in the packet. Therefore, the intermediate forward devices need not process the packet according to flow table entries. The controller does not need to generate flow table entries and issue them to the intermediate forward devices. In view of the above, the controller only needs to issue a flow table entry to the edge forward device, which reduces burden of the controller on issuing flow table entries and increases service deployment efficiency.

In view of the above, the edge forward device of the data flow needs to receive and save the flow table entry including the path information of the forwarding path of the data flow issued by the controller. The intermediate forward devices do not need to receive and save flow table entries. Therefore, operations such as table entry insertion, aging and refresh are avoided. Table entry matching operations are also avoided in the intermediate forward devices. Thus, software and hardware design and development of the intermediate forward device are simplified. There is no table entry scale restriction and TCAM cost problem. Service capacity of the whole SDN network is increased.

In addition, the intermediate forward device is not required to search flow table and forward the packet according to information such as IP address in the packet header. Therefore, IP addresses may be deployed repeatedly, which facilitates implementation of a VPN model.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

1. A method for processing a flow table entry in software defined networking (SDN) network, wherein the SDN network comprises a controller and at least one forward device, the method comprising:
receiving, by the controller, a packet from a forward device, and calculating a forwarding path for the packet;
generating by the controller a flow table entry used for instructing forwarding of the packet according to the calculated forwarding path, wherein an instruction set of the flow table entry includes an action of inserting a forwarding path link table in the packet, the forwarding path link table includes path information of the forwarding path; and
transmitting by the controller the flow table entry to the forward device from which the packet was received.

2. The method of claim 1, wherein the forwarding path link table further comprises a link table length, an initial value of the link table length equals to a total number of forward devices on the forwarding path;
the path information of the forwarding path comprises: device information of each forward device on the forwarding path, a sequence of the device information of the forward devices on the forwarding path complies with a sequence of the forward devices on the forwarding path; the device information of each forward device comprises: an identifier of the forward device and a port identifier of a forwarding port of the forward device from which the packet is forwarded, or comprises a port identifier of a forwarding port of the forward device from which the packet is forwarded.

3-7. (canceled)

8. A controller for use in a software defined networking (SDN) network, the controller comprising:
a processer;
a non-transitory machine readable storage medium storing instructions which are executable by the processor to:
receive a packet from a forward device;
calculate a forwarding path for the packet;
generate a flow table entry to instruct forwarding of the packet according to the forwarding path; wherein an instruction set of the flow table entry includes an action of inserting a forwarding path link table in the packet, the forwarding path link table includes path information of the forwarding path; and
transmit the flow table entry to said forward device from which the packet was received.

9. The controller of claim 8, wherein the forwarding path link table further comprises a link table length, an initial value of the link table length equals to a total number of forward devices on the forwarding path;
the path information of the forwarding path comprises: device information of each forward device on the forwarding path, a sequence of the device information of the forward devices on the forwarding path complies with a sequence of the forward devices on the forwarding path; the device information of each forward device comprises: an identifier of the forward device and a port identifier of a forwarding port of the forward device from which the packet is forwarded, or comprises a port identifier of a forwarding port of the forward device from which the packet is forwarded.

10. A forward device for use in a software defined networking (SDN) network; the forward device comprising:
a receiving module, to receive a packet from a client device or an external network connected with the SDN network, and receive a flow table entry used for instructing forwarding of the packet from the controller;
a searching module, to search a flow table of the forward device according to header information of the packet for a matching flow table entry after the receiving module receives the packet from the external network;
a transmitting module, to transmit the packet to the controller if the searching module does not find the matching flow table entry; and
an adding module, to add the flow table entry received by the receiving module into the flow table of the forward device, wherein an instruction set of the flow table entry includes an action of inserting a forwarding path link table in the packet, the forwarding path link table includes path information of the forwarding path.

11. The forward device of claim 10, wherein the forwarding path link table further comprises a link table length, an initial value of the link table length equals to a total number of forward devices on the forwarding path;
the path information of the forwarding path comprises: device information of each forward device on the forwarding path, a sequence of the device information of the forward devices on the forwarding path complies with a sequence of the forward devices on the forwarding path; the device information of each forward device comprises: an identifier of the forward device and a port identifier of a forwarding port of the forward device from which the packet is forwarded, or comprises a port identifier of a forwarding port of the forward device from which the packet is forwarded.

12. The forward device of claim 11, further comprising:
a processing module and a determining module;
the searching module is further to search the flow table of the forward device for the matching flow table entry after the adding module adds the flow table entry received by the receiving module into the flow table of the forward device;
the processing module is to (i) insert the forwarding path link table in the packet according to the action in the instruction set of the forwarding path link table of the packet, and (ii) pop out device information of a first forward device from the forwarding path link table, and subtract 1 from the link table length;
the determining module is to determine whether the link table length is 0 after the subtraction performed by the processing module; and
the transmitting module is further to, if the link table length is not 0, transmit the packet via a port identified by a port identifier in the device information popped out by the processing module.

13. The forward device of claim 12, wherein
the receiving module is further to receive a packet containing a forwarding path link table from an adjacent forward device; and
the processing module is further to, after the receiving module receives the packet from the adjacent forward device, (i) pop out device information of a first forward device from the forwarding path link table of the packet, and (ii) subtract 1 from the link table length of the forwarding path link table.

14. The forward device of claim 12, wherein
in response to the determining module determining that the link table length is 0, the processing module is to pop out the forwarding path link table from the packet; and
the transmitting module is to transmit the packet via a port identified by a port identifier in the device information popped out by the processing module.
